(19) United States
(12) Patent Application Publication
(10) Pub. No.: US 2025/0140062 A1
(43) Pub. Date: May 1, 2025

(54) ARTICLE SUPPLY APPARATUS AND ARTICLE SUPPLY SYSTEM

(71) Applicant: BANDAI CO., LTD., Tokyo (JP)

(72) Inventors: Hiroki KOBAYASHI, Tokyo (JP); Hajime KONDO, Tokyo (JP)

(21) Appl. No.: 18/914,211

(22) Filed: Oct. 13, 2024

(30) Foreign Application Priority Data
Oct. 30, 2023 (JP) 2023-185725

(51) Int. Cl. G07F 17/32; G07F 11/00; G07F 17/00

(52) U.S. Cl. CPC G07F 17/3248; G07F 11/005; G07F 17/0014; G07F 17/3209

(57) ABSTRACT

An article supply apparatus comprises a main body unit, an accommodation unit configured to be attachable to the main body unit and to accommodate the first article, a supply unit configured to supply the first article accommodated in the accommodation unit, wherein the supply unit is configured to supply a second article different from the first article on condition of responding to a questionnaire.

### CROSS-REFERENCE TO RELATED APPLICATIONS

The disclosure of Japanese Patent Application No. 2023-185725 filed on Oct. 30, 2023 including specification, drawings and claims is incorporated herein by reference in its entirety.

### TECHNICAL FIELD

The present invention relates to an article supply apparatus and an article supply system.

### BACKGROUND

Conventionally, there has been a system in which an order management device and information processing program therefor is provided to improve response rates for surveys. For example, in Japanese Patent Application Publication No. 2022-123502, the order management device includes an order reception unit, a generation unit, a confirmation unit, a display unit, and a grant unit. The order reception unit receives an order(s) for goods consumed in stores. The generation unit generates order management data that includes a list of order of goods the order reception unit receives. The confirmation unit confirms that the goods ordered by the order reception unit are subject to the survey. The display unit displays a screen prompting the customer to answer the survey on a display device installed in the store. The grant unit grants a benefit to the customer by updating the order management data if the survey is answered before the payment is made based on the order management data generated by the order reception unit.

### SUMMARY

### Technical Problem

Japanese Patent Application Publication No. 2022-123502 teaches that the response rate of a survey is improved in an order management device and an information processing program. Furthermore, Japanese Patent Application Publication No. 2022-123502 is not related to a type of a selling, which uses an article supply apparatus, nor does it aim to enhance the player's (user's) interest.

It is an object of the present invention to provide an article supply apparatus and an article supply system capable of enhancing the user's interest.

### Solution to Problem

One aspect of the present invention is an article supply apparatus. The article supply apparatus comprises a main body unit, an accommodation unit configured to be attachable to the main body unit and to accommodate first articles, a supply unit configured to supply one of the first articles accommodated in the accommodation unit, wherein the supply unit is configured to supply a second article different from the first article when a questionnaire is responded.

One aspect of the article supply system of the present invention is an article supply system. The article supply system comprises an article supply apparatus configured to supply a first article and a second article, a user terminal, and an information management device configured to communicate with the article supply apparatus and the user terminal, wherein the article supply apparatus includes a main body unit, an accommodation unit configured to be attachable to the main body unit and to accommodate the first article and the second article, a supply unit configured to supply the first article and the second article accommodated in the accommodation unit, and a receiving unit configured to receive information, the user terminal includes a transmitting unit configured to transmit information to the information management device, the information management device includes a sending/receiving unit configured to send and receive information related to questionnaire response information transmitted from the user terminal, the supply unit is configured to supply the second article when the information related to the questionnaire response information sent from the information management device, is received.

### Advantageous Effect of Invention

According to the present invention, it is possible to provide an article supply apparatus and an article supply system that can enhance the user's interest.

### BRIEF DESCRIPTION OF DRAWINGS

FIG. 1 is a schematic configuration diagram showing an article supply system according to an embodiment of the present invention;

FIG. 2 is a perspective view showing an example of an article supply apparatus in the article supply system;

FIG. 3 is a cross-sectional view of the main part of the article supply apparatus shown in FIG. 2;

FIG. 4 is a flowchart showing an example of supply of goods in the article supply system;

FIG. 5 is a flowchart showing a first modified example of a supply flow of an article in the article supply system;

FIG. 6 is a flowchart showing a second modified example of a supply flow of an article in the article supply system; and

FIG. 7 is a flowchart showing a third modified example of a supply flow of an article in the article supply system.

### DETAILED DESCRIPTION

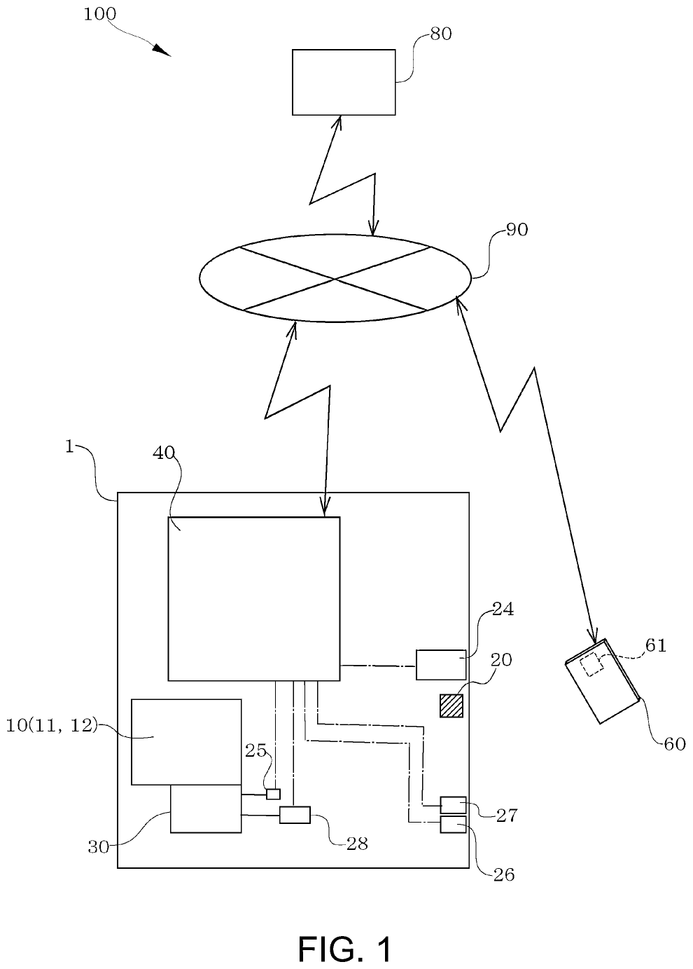

Hereinafter, an article supply apparatus 1 according to an embodiment of the present invention will be described with reference to the drawings. FIG. 1 is a schematic configuration diagram showing an article supply system 100 according to an embodiment of the present invention.

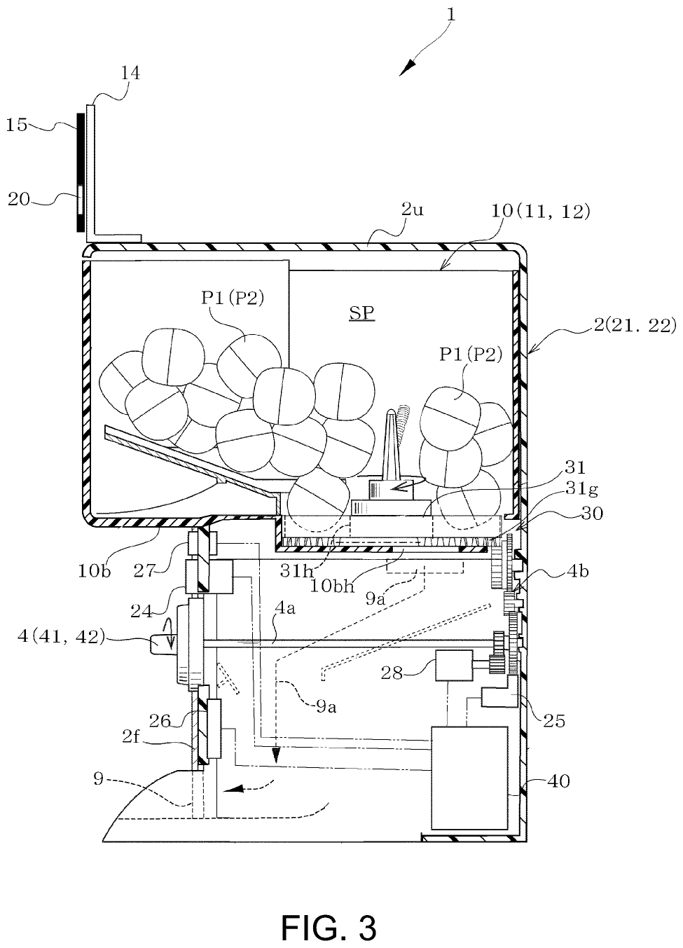

The article supply system 100 shown in FIG. 1 includes an article supply apparatus 1 (hereinafter simply referred to as “apparatus”) capable of supplying a first article P1 and a second article P2 (see FIG. 3), a user terminal 60, an information management device 80 (hereinafter referred to as “server 80”) which manages information with specific data, and a communication line 90 such as the Internet for connecting the server 80, the apparatus 1, and the user terminal 60. More specifically, for example, the system allows a user to acquire the second article P2, which is another article, without requiring physical payment such as coins after purchasing the first article P1 containing a specific character toy, on condition that the user answers a survey via the user terminal 60.

The user terminal 60 is capable of the internet communication and has a camera unit 61 capable of capturing an image such as a two-dimensional code, and a near-field communication (NFC) function. In other words, the user terminal 60 is equipped with a transmission unit capable of transmitting information to the server 80 and a reception unit capable of receiving information from the server 80. The server 80 is also equipped with a transmission/reception unit capable of transmission and reception of information with the user terminal 60 and the apparatus 1. Although the details of the supply unit 30 (see FIG. 3) of the apparatus 1, which is capable of supplying the second article P2, will be explained later, it is configured to supply the second article P2, which is a special article (prize article), on condition that information related to survey response information sent from the server 80 is received.

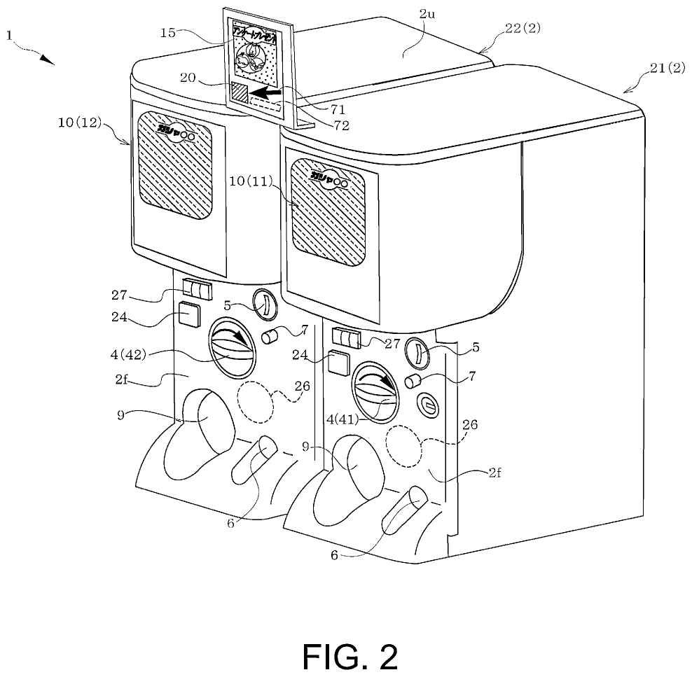

FIG. 2 is a perspective view of the main body 2 of the apparatus 1. FIG. 3 is a cross-sectional view of a first main body unit 21 of the apparatus 1. As shown in FIG. 2, the apparatus 1 has a structure in which the first main body unit 21 and a second main body unit 22, each having basically the same structure, are installed side by side. The first articles P1 stored in the first accommodation unit 11 of the accommodation unit 10 on one side (right side) thereof and the second articles P2 stored in the second accommodation unit 12 of the accommodation unit 10 on the other side (left side) thereof can be supplied one by one from the first and second main body units 21 and 22, respectively. As will be described later, the apparatus 1 can be used to purchase the first article P1 through the first main body unit 21. After the purchase, the second article P2 can be supplied through the second main body unit 22 when certain conditions, such as answering a survey, are met.

As shown in FIG. 3, inside the first main body unit 21, are provided the first accommodation unit 11 which can be attached to the first main body unit 21 and stores articles, a supply unit 30 which can supply the first article P1 stored in the internal space SP of the first accommodation unit 11, a lock unit 25 which locks an operation of the supply unit 30, a control unit 40 which controls unlocking of the lock unit 25 when specific conditions are met, a first operation unit 41 which is provided to rotate the supply unit 30 after the lock is released, and a passage unit 9a which allows the first article P1 to roll and pass from the first accommodation unit 11 to the supply port 9.

The second article P2 stored in the second accommodation unit 12 can be supplied by an operation of the second operation unit 42 on condition that the first article P1 is purchased and, for example, a survey is answered. The user who purchases the first article P1 can obtain the second article P2 by rotating the second operation unit 42. The configuration of the second main body unit 22 side is the same as that of the first main body unit 21, so the explanation will be omitted, but the control unit 40 is provided inside each main body unit, to control operations of the apparatus as one apparatus as a whole by sharing communication information with the user terminal 60 and the server 80.

The supply unit 30 includes two or more holding holes 31h capable of holding the first articles P1 (or second articles P2). The holding holes are formed in a rotating disk 31, which is rotatably arranged on the bottom 10b of the first accommodation unit 11 (or second accommodation unit 12). The rotating disk 31 randomly selects one of the first articles P1 (or second articles P2) from the first accommodation unit 11 through a through hole 10bh formed in the bottom 10b by rotating and supplies it from the holding hole 31h to the passage unit 9a.

The first articles P1 (or second articles P2) are, for example, formed of a synthetic resin material with appropriate rigidity and are approximately spherical in shape, thereby making it easy to roll. Additionally, the first articles P1 (or second articles P2) are respectively covered with a wrapping film as needed, and are supplied to the user one by one without being separated or damaged during supply from the apparatus 1.

The control unit 40 is provided in the apparatus 1 and capable of transmitting and receiving data with external sources. The control unit 40 is connected to a camera 24 which can acquire image information, a light emitting unit 27, and an audio generating unit 26. They are provided on the front face 2f to notify the user. The control unit 40 is connected to a locking unit 25, which locks an operation of the first operation unit 41 (second operation unit 42) and allows the locking unit 25 to be released when specific conditions are met. The details of the first operation unit 41 and the second operation unit 42, will be described later. However, the first operation unit 41, as mentioned earlier, can be operated via the control unit 40 under a condition of payment of the price, regardless of responding to a survey. On the other hand, the second operation unit 42 can be operated via the control unit 40 without requiring payment of the price but under a certain condition such as responding to a survey.

A rack gear 31g is provided on the lower end of the rotary disk 31 of the supply unit 30, and a gear train 4b is engaged with this rack gear 31g. Furthermore, the rotation shaft 4a of the first operation unit 41 is arranged to drive the gear train 4b. The locking unit 25, which is controlled by the control unit 40, is configured to engage with the gear train 4b to lock the rotation of the gear train 4b. Moreover, a drive unit 28 which drives the gear train 4b via the control unit 40 is provided so that the rotary disk 31 can also be driven by power.

Since the drive unit 28 is provided, the supply unit 30 can supply the first article P1 by operating the drive unit 28 after a certain period has elapsed, under the control of the control unit 40, without requiring a rotation operation of the first operation unit 41. Similarly, for the second operation unit 42, a control is performed so that the second article P2 is supplied after a certain period has elapsed, without requiring a rotation operation of the second operation unit 42 after the predetermined conditions are satisfied.

In this embodiment, a holding plate 14 is provided at, for example, the upper end 2u of the main body 2, and a poster 15 with information such as display of a survey gift is provided on the front face of this holding plate 14. For example, the poster 15 displays a catchphrase like “Answer the survey to win . . . ”. Additionally, a two-dimensional code 20, which encodes identification information (device ID) for identifying the apparatus 1, is provided on the poster 15. The user terminal 60 can acquire the device ID of the apparatus 1 by capturing this two-dimensional code 20 with the camera 61. The poster 15 also contains information about the implementation of the survey gift, such as how to obtain the gift. As shown in FIG. 2, near the location where the two-dimensional code 20 is provided, there may be an arrow mark 71 or an explanatory note 72, as needed, to make it easier to acquire the two-dimensional code 20.

Among the conditions for obtaining an article in the article supply system 100 using the apparatus 1, the conditions for acquiring the first article P1 include obtaining the device ID (identification information) from the two-dimensional code 20, which is an identification information unit part provided on the front of the main body 2, with the user terminal 60, and making electronic payment as the payment of the price after obtaining the identification information with the user terminal 60. On the other hand, the conditions for acquiring the second article P2 include making the electronic payment as the consideration for the first article P1, answering a survey via the user terminal 60 if a survey response is required after supplying the first article P1, obtaining, with the user terminal 60, the first information (hereinafter referred to as “reward code”) granted when the survey is answered, ensuring that elapsed time after the survey response (time when the reward code is acquired) is within a certain period, and transmitting the reward code and the device ID (identification information) obtained by the user terminal 60 to the apparatus 1 (this transmission can be done using a server 80 or not).

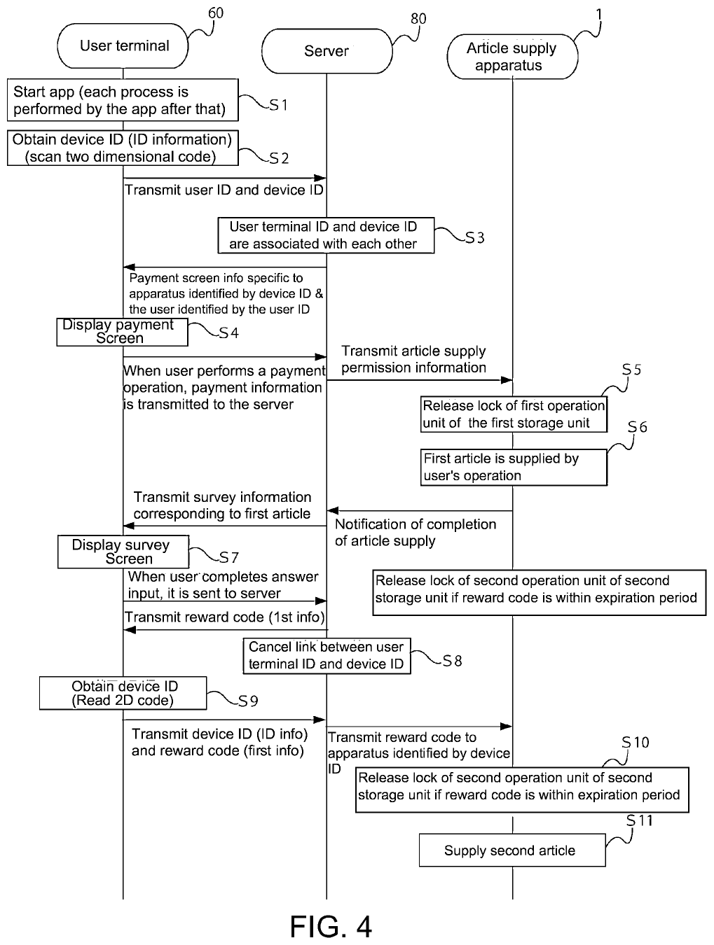

FIG. 4 is a flowchart showing an example of supply flow of the first article P1 and the second article P2 in the article supply system 100. Described below is the operation of the actual article supply system 100 and the flow of article supply. First, to use the article supply system 100, the user, for example, registers for “Survey Gift of Capsule Toy” on the user terminal 60 and installs the required application. Then, the user starts the obtained application using the user terminal 60 (Step 1).

Using the camera 61 of the user terminal 60, the user captures the two-dimensional code 20 (identification information unit) provided on the apparatus 1 to obtain the device ID (identification information) of the apparatus 1 (Step 2).

Next, the application of the user terminal 60 sends the user terminal ID and the device ID (identification information) for identifying the apparatus 1 to the server 80. As a result, the user terminal ID and the device ID are associated with the server 80 (Step 3).

Since the linking of the user terminal ID and device ID has been performed as described above, the server 80 sends payment screen information specific to the apparatus identified by the device ID and specific to the user identified by the user ID, to the user terminal 60. This allows the payment screen to be displayed on the user terminal 60 (Step 4).

Next, the user performs the payment operation using the displayed payment screen. As a result, the payment information is sent to the server 80. After that, the server 80 sends article supply permission information (information for permitting the supply of the first article P1) to the apparatus 1. Upon receiving this article supply permission information, the control unit 40 of the apparatus 1 unlocks the lock by the locking unit 25 to allow the operation of the first operation unit 41 (Step 5).

Upon unlocking the lock, the user is notified that an operation of the first operation unit 41 is now available, for example, by activating the audio unit 26 and/or the light emitting unit 27. This allows the user to rotate the first operation unit 41 to obtain the first article P1 from the supply port 9 (Step 6).

Once the supply of the first article P1 is completed, the apparatus 1 sends an article supply completion notification to the server 80. In response to this notification, the server 80 sends survey information corresponding to the first article P1 to the user terminal 60. Note that the server 80 may send the survey information to the user terminal 60 upon sending the article supply permission information to the apparatus 1, even without receiving the article supply completion notification from the apparatus 1.

Since the first articles P1 stored in the apparatus 1 may differ depending on the apparatuses 1, the content of the survey corresponding to the device ID (the survey content corresponding to the first articles P1 stored in the apparatus 1) will be sent as the survey information relating to the first article P1. The survey screen is then displayed on the user terminal 60 (Step 7).

Subsequently, the user inputs answers to the questionnaire, and after performing the required operation, the response information is transmitted to the server 80. The questionnaire consists of multiple questions that include matters related to the first article P1. The conditions under which a response is considered complete are preset, such as when the user answers all the questions, when the user answers at least certain specified questions among multiple questions, or when the user answers any one of the questions. The response information is transmitted to the server 80 only when a response satisfying the preset condition(s) is made.

When the server 80 receives the response information, it sends a reward code (first information) to the user terminal 60. After receiving the reward code (first information), a specific time period is set for the next action, so that the user is not required to immediately proceed with the next action. For example, the next day or two days after the day the first article P1 was purchased, serves as the start date.

Furthermore, once the reward code is sent to the user terminal 60, the server 80 prepares for the next linking operation for the apparatus 1 by canceling the linkage between the user terminal ID and the device ID (step 8).

The user who obtained the reward code (first information) acquires the device ID again by scanning the two dimensional code 20 of the apparatus 1 (step 9). Then, the device ID and the reward code (first information) are transmitted from the user terminal 60 to the server 80. In response thereto, the server 80 sends the reward code (first information) to the apparatus 1 identified by the device ID. The apparatus 1, after confirming that the date for the reward code (first information) such as reward code acquisition date or expiration date of the reward is within its valid period (the aforementioned specific time setting), unlocks the second operation unit 42 of the second main body unit 22 (step 10).

By unlocking, the apparatus 1 notifies the user that the second operation unit 42 is now operable, for example, by activating the audio generating unit 26 and/or the light emitting unit 27 in the second main body unit 22. The user recognizes that the second operation unit 42 is operable, by this notification, rotates the second operation unit 42, and obtains the second article P2 from the supply port 9 (step 11).

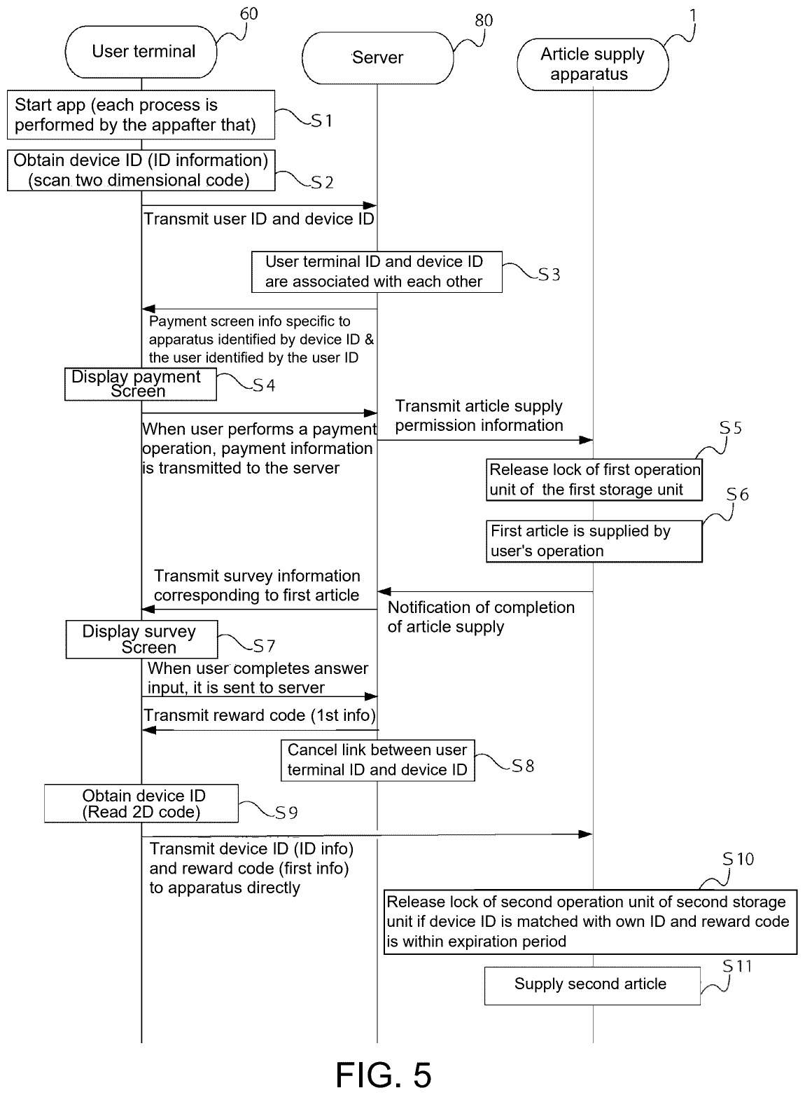

FIG. 5 is a flowchart showing a first modified example of the article supply flow in the article supply system 100.

In the first modified example shown in FIG. 5, steps 1 to 9 are the same as those shown in FIG. 4, but in the example shown in FIG. 5, the server 80 is not used after step 9 thereof. In this case, in step 9, the scanned device ID (identification information) and the obtained reward code (first information) are transmitted directly from the user terminal 60 to the apparatus 1 by a communication unit such as NFC device. In step 10, the apparatus 1 confirms that the device ID transmitted from the user terminal 60 matches the ID of the apparatus 1 itself, and that the reward code is within the valid period, then unlocks the second operation unit 42. Subsequent operations and actions are performed as in the case shown in FIG. 4, and the second article P2 is supplied.

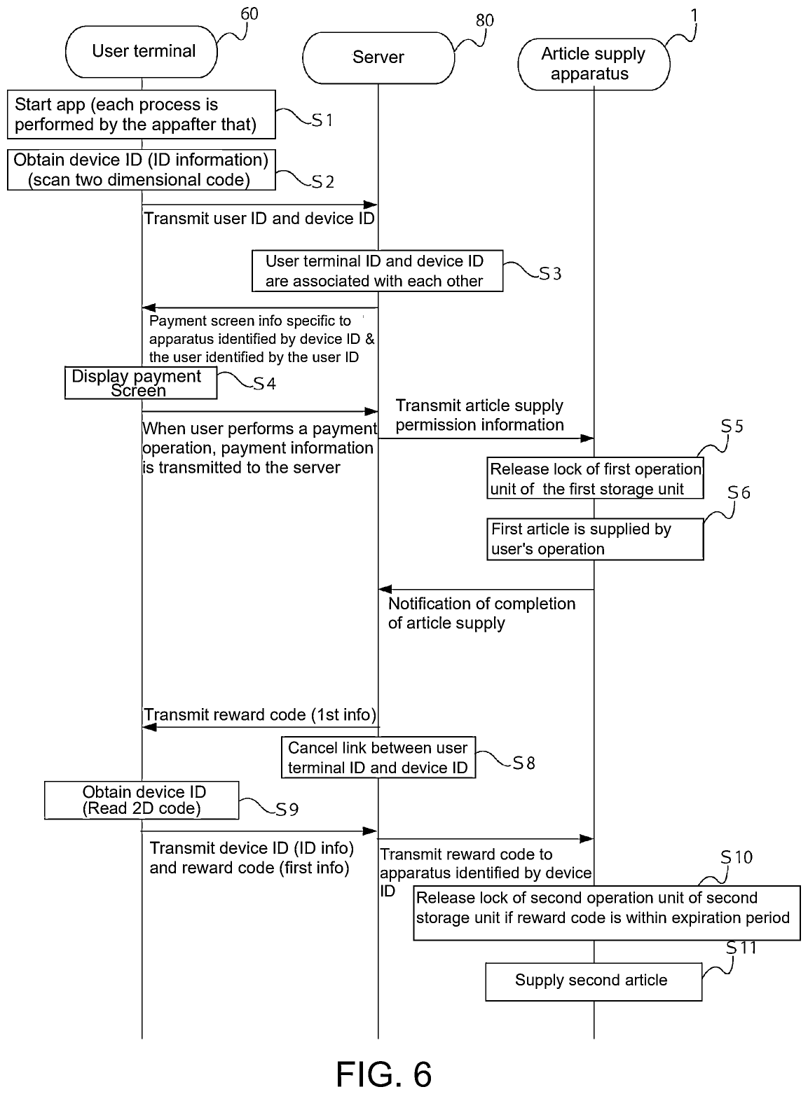

FIG. 6 is a flowchart showing a second modified example of the article supply flow in the article supply system 100.

In the second modified example shown in FIG. 6, steps 1 to 6 are the same as those shown in FIG. 4. In this modified example, after the first article P1 is supplied and the article supply completion notification is sent from the apparatus 1 to the server 80, the questionnaire information corresponding to the first article P1 is not sent to the user terminal 60, and instead, the reward code (first information) is sent thereto. That is, this system is different from that in FIG. 4 in that the flow show in FIG. 6 does not include step 7 in FIG. 4. Therefore, the flow from step 8 to step 11 after acquiring the reward code (first information) is the same as that shown in FIG. 4. In the second modified example, the second article P2 is supplied as a reward, on condition that the first article P1 is purchased, independent of the questionnaire response.

Moreover, in the embodiment shown in FIG. 6, the second article P2 is supplied through the apparatus 1 after acquiring the reward code (first information) by purchasing the first article P1. However, the second article P2 may be one which cannot be supplied by apparatus 1. In such a case, for example, the user may take the reward code to a specific store (e.g., a convenience store) and receive the second article P2 in exchange for the reward code. This method is effective when the second article P2 is not suitable for supply from apparatus 1.

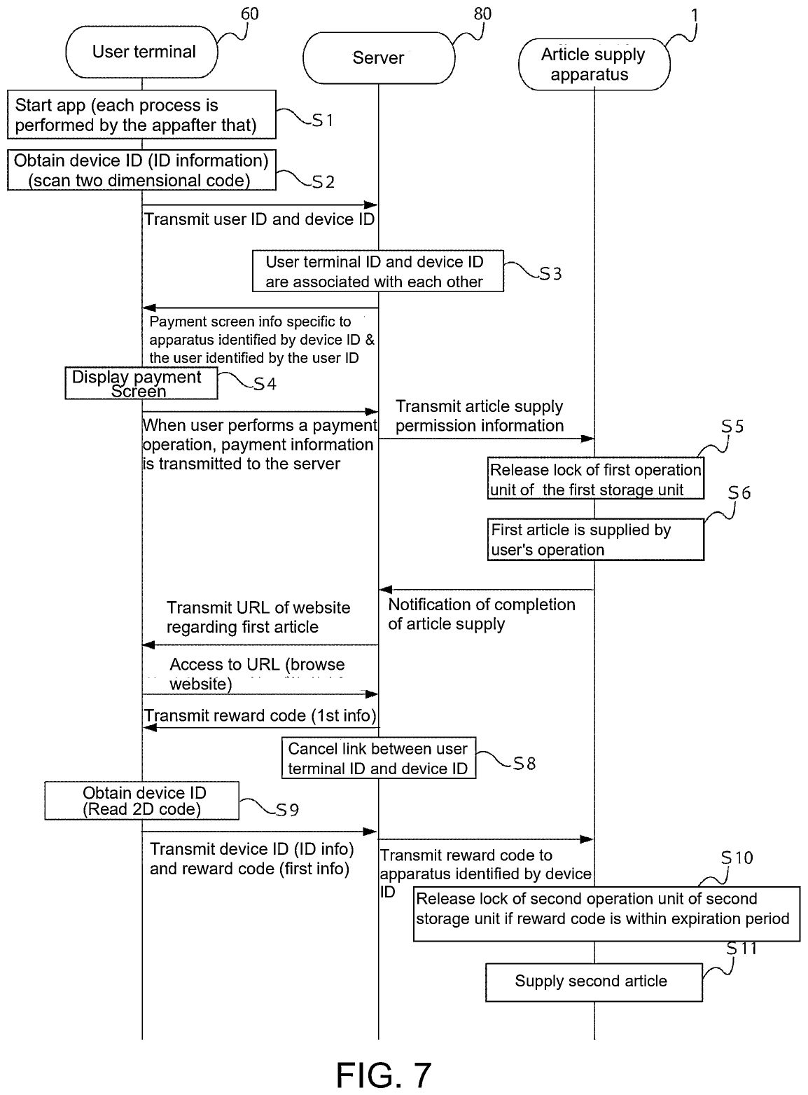

FIG. 7 is a flowchart showing a third modified example of the article supply flow in the article supply system 100.

In the third modified example shown in FIG. 7, steps 1 to 6 are the same as those shown in the flowchart of FIG. 4. In this modified example, after the first article P1 is supplied and the article supply completion notification is sent from the apparatus 1 to the server 80, a URL for a website related to the first article P1 is sent, instead of sending the questionnaire information corresponding to the first article P1 to the user terminal 60. Then, when the user browses the website (accesses the website), the server 80 confirms this access and sends the reward code to the user. The subsequent flow follows the same steps as those shown in FIG. 4, and the second article P2 is supplied.

The apparatus 1 functions as part of the article supply system 100 as described above. However, separately from the article supply system 100, it is also configured to supply articles through normal payment (coin payment). In this case, as shown in FIG. 2, coin insertion slots 5, a coin return slot 6, and a coin return button 7 are provided in both the first main body unit 21 and the second main body unit 22. When the required coins are inserted, the control unit 40 unlocks the locking unit 25, enabling the rotation operation of the first operation unit 41 and the second operation unit 42.

As described above, in this embodiment, the apparatus 1 supplies the second article P2, which is different from the first article P1, on condition that a response to a questionnaire is required, instead of payment. This increases the user's motivation to respond to the questionnaire, thereby improving the response rate and allowing the supplier to obtain information to boost sales. Additionally, the user can obtain other articles without payment, thereby enhancing their enjoyment. Furthermore, since the purchase of the first article P1 is done through electronic payment, ease of purchase is improved.

In this embodiment, since the questionnaire includes content related to the first article P1, the seller can obtain direct user response information regarding the sold articles. Moreover, since the questionnaire responses are made by using the user terminal 60, the user can easily respond, and the questionnaire response data can be easily accumulated as digitized data.

In this embodiment, the response conditions of questionnaire may be set so as to be satisfied when all questions are required to be answered, when at least specific questions among multiple questions are required to be answered, or any of the multiple questions is answered. By making any of the settings available, it is possible to maximize the effectiveness of the questionnaire by changing to the current setting to new setting, considering the balance between the quality of response information to be collected and user side convenience,

In this embodiment, since the necessary information is provided via the user terminal 60 during article sales, the linkage between the user terminal 60 and the apparatus 1 can be easily made based on identification information of the apparatus 1, the reliability of electronic payments can be ensured. Additionally, all operations can be performed at the user's location, enhancing convenience.

Moreover, in this embodiment, since the supply unit 30 is unlocked on condition that the reward code (first information) and identification information obtained using the user terminal 60 are sent to the apparatus 1, the second article P2 can be easily and reliably obtained from the identified apparatus 1 in front of the user.

In this embodiment, the first article P1 and the second article P2 are respectively accommodated in separate accommodation units, that is, the first and second accommodation units 11 and 12, and their supply operations are controlled separately by the first and second operation units 41 and 42. Thus, the operations for purchasing the first article P1 by using the first operation unit 41 and obtaining the reward article using the second operation unit 42 can be clearly distinguished, thereby improving the operability of the apparatus 1.

In this embodiment, the supply unit 30 is configured to automatically rotate after a certain period has elapsed. In other words, if a certain period has passed after unlocking the locking unit 25, the apparatus 1 supplies the articles regardless of the operation of the operation unit. This prevents the user from forgetting to retrieve the article if the operation unit cannot be operated or if the user does not operate the operation unit.

In this embodiment, when the second article P2 is supplied, conditional on the supply of the first article P1 itself, instead of requiring a response to a questionnaire after the supply of the first article P, it is ensured that the special article is immediately obtained, so that the desire to purchase the first article P1 can be increased. Furthermore, since this system is designed to be adaptable even in case where the second article P2 is configured so as not to be supplied from the apparatus 1, thereby allowing, for example, the second article P2 to be an article that cannot be supplied by the apparatus 1 (an article not compatible with the apparatus 1).

In this embodiment, the article supply system 100 can supply the second article P2 on the condition of browsing a website related to the first article P1, instead of requiring a response to a questionnaire after the supply of the first article P1. This allows the user to obtain the second article P2 more easily, and it can contribute to the promotion and increased sales of the first article P1 on the supplier's side.

The embodiments of the present invention have been described above, but the present invention can be appropriately modified within the scope of its technical concept. For example, in the above embodiment, the apparatus 1 is configured with two main body units 2 arranged side by side, but this is not limited to this configuration, and more body parts 2 can be arranged side by side, allowing for multiple types of purchasable products and gifts.

Moreover, in the above embodiment, the two-dimensional code 20 of the identification information part is provided on the poster 15, but this configuration is not limited to this, and it may be provided on the main body unit 2 of the apparatus 1 or on the front side of the accommodation unit 10.

As explained above, the present specification discloses the following articles.

(1) An article supply apparatus comprises: a main body unit, an accommodation unit that can be attached to the main body unit and is capable of storing the first article, a supply unit that can supply the first article stored in the accommodation unit, wherein the supply unit is capable of supplying a second article different from the first article on condition of responding to a questionnaire.

(2) In the article supply apparatus according to (1), the supply unit is capable of supplying the first article on condition of payment of consideration for the first article and is capable of supplying the second article without the payment of consideration.

(3) In the article supply apparatus according to (2), the supply unit is capable of supplying the second article on condition that the payment of consideration for the first article is made electronically.

(4) In the article supply apparatus according to any one of (1) to (3), the questionnaire includes multiple questions, and the supply unit is capable of supplying the second article on condition of responding to all of the questions.

(5) In the article supply apparatus according to any one of (1) to (3), the questionnaire includes multiple questions, and the supply unit is capable of supplying the second article on the condition of responding to at least specific questions.

(6) In the article supply apparatus according to any one of claims 1-3, the questionnaire includes multiple questions, and the supply unit is capable of supplying the second article on the condition of responding to any one of the questions.

(7) In the article supply apparatus according to any one of (1) to (6), the questionnaire includes questions related to the first article.

(8) In the article supply apparatus according to any one of (1) to (7), after the supply of the first article, the supply unit can supply the second article when the questionnaire is responded via a user terminal.

(9) In the article supply apparatus according to (8), the supply unit can supply the second article on the condition of acquiring first information, which is granted when the questionnaire is responded, on the user terminal.

(10) In the article supply apparatus according to (9), identification information part, which can identify the main body unit, is provided on a front face of the main body unit, and the supply unit can supply the second article on the condition that the identification information is acquired from the identification information part by the user terminal.

(11) In the article supply apparatus according to (10), the supply unit can supply the second article on condition that the first information acquired on the user terminal and the identification information, or at least the first information, is transmitted to the main body unit.

(12) In the article supply apparatus according to (10) or (11), the supply unit can supply the second article on the condition that the first information acquired on the user terminal and the identification information, or at least the first information, is transmitted to the main body unit via an information management device.

(13) In the article supply apparatus according to any one of (10) to (12), the supply unit can supply the first article on the condition that the identification information is acquired on the user terminal from the identification information part.

(14) In the article supply apparatus according to (13), the supply unit can supply the first article on the condition of payment of consideration after the identification information is acquired on the user terminal.

(15) In the article supply apparatus according to any one of (1) to (14), the supply unit can supply the second article only when a certain period of time, or less, passes after the questionnaire is responded to.

(16) In the article supply apparatus according to any one of (1) to (15), the accommodation unit includes at least a first accommodation unit and a second accommodation unit, and the first accommodation unit stores the first article, and the second accommodation unit stores the second article.

(17) The article supply apparatus according to any one of (1) to (16), further comprises an operation unit that can be operated for article supply from the supply unit, wherein the supply unit can supply the first article and the second article on the condition that the operation unit is operated.

(18) In the article supply apparatus according to (17), the operation unit includes at least a first operation unit and a second operation unit, the first operation part can be operated on the condition of payment, and the second operation part can be operated without the condition of payment.

(19) In the article supply apparatus according to (18), the first operation part can be operated without the condition of responding to the questionnaire, and the second operation part can be operated on the condition of responding to the questionnaire.

(20) In the article supply apparatus according to (18) or (19), the supply unit can supply the first article after a certain time has elapsed without requiring the operation of the first operation unit, and can supply the second article after a certain time has elapsed without requiring the operation of the second operation unit.

(21) An article supply system comprises an article supply apparatus capable of supplying a first article and a second article, a user terminal, and an information management device capable of communicating with the article supply apparatus and the user terminal, wherein the article supply apparatus includes a main body unit, an accommodation unit that can be attached to the main body unit and is capable of storing articles, a supply unit capable of supplying the first article and the second article stored in the accommodation unit, and a receiving unit capable of receiving information, the user terminal includes a transmitting unit capable of transmitting information to the information management device, the information management device includes a sending/receiving unit capable of sending and receiving information related to questionnaire response information transmitted from the user terminal, the supply unit is capable of supplying the second article on the condition of receiving the information related to the questionnaire response information sent from the information management device.

(22) In the article supply apparatus according to (1), the supply unit can supply the second article on the condition of the supply of the first article, instead of requiring a response to the questionnaire after the supply of the first article.

(23) In the article supply apparatus according to (22), the second article is either an article that can be supplied by the article supply apparatus or an article that cannot be supplied by the article supply apparatus.

(24) In the article supply apparatus according to (1), the supply unit can supply the second article when a website is browsed, instead of requiring a response to the questionnaire after the first article is supplied.

(25) The article supply apparatus according to (24), wherein the website contains information related to the first article.

1. An article supply apparatus comprising:
a main body unit;
an accommodation unit configured to be attachable to the main body unit and to accommodate a first article;
a supply unit configured to supply the first article accommodated in the accommodation unit,
wherein the supply unit is configured to supply a second article different from the first article on condition of responding to a questionnaire.

2. The article supply apparatus according to claim 1, wherein the supply unit is configured to supply the first article on condition that consideration for the first article is paid, and to supply the second article without payment of consideration for the second article.

3. The article supply apparatus according to claim 2, wherein the supply unit is configured to supply the second article when the consideration for the first article is paid electronically.

4. The article supply apparatus according to claim 1, wherein the questionnaire includes two or more questions, and the supply unit is configured to supply the second article on condition of responding to all of the two or more questions.

5. The article supply apparatus according to claim 1, wherein the questionnaire includes two or more questions, and the supply unit is configured to supply the second article on condition of responding to at least a specified question among the two or more questions.

6. The article supply apparatus according to claim 1, wherein the questionnaire includes two or more questions, and the supply unit is configured to supply the second article on condition of responding to any one of the questions.

7. The article supply apparatus according to claim 1, wherein the questionnaire includes a question related to the first article.

8. The article supply apparatus according to claim 7, wherein after the first article is supplied, the supply unit is configured to supply the second article when the questionnaire is responded via a user terminal.

9. The article supply apparatus according to claim 8, wherein the supply unit is configured to supply the second article on condition of acquiring, on the user terminal, first information which is granted when the questionnaire is responded.

10. The article supply apparatus according to claim 9, wherein identification information part, which can identify the main body unit, is provided on a front face of the main body unit, and the supply unit is configured to supply the second article when identification information is acquired from the identification information part by the user terminal.

11. The article supply apparatus according to claim 10, wherein the supply unit is configured to supply the second article when the first information acquired on the user terminal and the identification information, or at least the first information, is transmitted to the main body unit.

12. The article supply apparatus according to claim 11, wherein the supply unit is configured to supply the second article when the first information acquired on the user terminal and the identification information, or at least the first information, is transmitted to the main body unit via an information management device.

13. The article supply apparatus according to claim 12, wherein the supply unit is configured to supply the first article when the identification information is acquired on the user terminal from the identification information part.

14. The article supply apparatus according to claim 13, wherein the supply unit is configured to supply the first article when consideration therefor is paid after the identification information is acquired by the user terminal.

15. The article supply apparatus according to claim 1, wherein the supply unit is configured to supply the second article only when a certain period of time, or less, passes after the questionnaire is responded to.

16. The article supply apparatus according to claim 1, wherein the accommodation unit includes a first accommodation unit and a second accommodation unit, and the first accommodation unit accommodates the first article, and the second accommodation unit accommodates the second article.

17. The article supply apparatus according to claim 16, further comprising an operation unit configured to be operated for article supply by the supply unit, wherein the supply unit is configured to supply the first article and the second article when the operation unit is operated.

18. The article supply apparatus according to claim 17, wherein the operation unit includes a first operation unit and a second operation unit, and the first operation part is operable when the consideration is paid, and the second operation part is operable without consideration payment.

19. The article supply apparatus according to 18, wherein the first operation unit is operable without responding to the questionnaire, and the second operation part is operable when the questionnaire is responded to.

20. The article supply apparatus according to claim 19, wherein the supply unit is configured to supply the first article without requiring an operation of the first operation unit after a certain time has elapsed, and to supply the second article without requiring an operation of the second operation unit after a certain time has elapsed.

21. An article supply system comprising:
an article supply apparatus configured to supply a first article and a second article;
a user terminal; and
an information management device configured to communicate with the article supply apparatus and the user terminal,
wherein the article supply apparatus includes
a main body unit,
an accommodation unit configured to be attachable to the main body unit and to accommodate the first article and the second article,
a supply unit configured to supply the first article and the second article accommodated in the accommodation unit; and
a receiving unit configured to receive information, the user terminal includes
a transmitting unit configured to transmit information to the information management device,
the information management device includes
a sending/receiving unit configured to send and receive information related to questionnaire response information transmitted from the user terminal,
the supply unit is configured to supply the second article when the information related to the questionnaire response information sent from the information management device, is received.

22. The article supply apparatus according to according to claim 1, wherein the supply unit is configured to supply the second article when the first article is supplied, instead of requiring a response to the questionnaire after the first article is supplied.

23. The article supply apparatus according to claim 1, wherein the supply unit is configured to supply the second article when a specified website is browsed, instead of requiring a response to the questionnaire after the first article is supplied.

24. The article supply apparatus according to claim 23, wherein the website contains information related to the first article.
